(19) United States
(12) Patent Application Publication
(10) Pub. No.: US 2013/0127273 A1
(43) Pub. Date: May 23, 2013

(54) HYDRODYNAMIC BEARING ASSEMBLY AND MOTOR INCLUDING THE SAME

(71) Applicant: Ta Kyoung LEE, Hwaseong (KR)

(72) Inventor: Ta Kyoung LEE, Hwaseong (KR)

(73) Assignee: SAMSUNG ELECTRO-MECHANICS CO., LTD., Suwon (KR)

(21) Appl. No.: 13/358,917

(22) Filed: Jan. 26, 2012

(30) Foreign Application Priority Data
Nov. 17, 2011 (KR) 10-2011-0120233

(51) Int. Cl. F16C 32/06; H02K 7/08

(52) U.S. Cl. 310/90; 384/100; 384/114; 384/118; 384/112

(57) ABSTRACT

There are provided a hydrodynamic bearing assembly and a motor including the same. The hydrodynamic bearing assembly includes: a sleeve having a shaft hole into which a shaft is rotatably inserted; and a hub fixed to an upper end of the shaft and extended in an outer radial direction, wherein an upper surface of the sleeve and a lower surface of the hub have an oil interface formed therebetween to seal oil.

### CROSS-REFERENCE TO RELATED APPLICATIONS

This application claims the priority of Korean Patent Application No. 10-2011-0120233 filed on Nov. 17, 2011, in the Korean Intellectual Property Office, the disclosure of which is incorporated herein by reference.

### BACKGROUND OF THE INVENTION

1. Field of the Invention

The present invention relates to a hydrodynamic bearing assembly and a motor including the same, and more particularly, to a hydrodynamic bearing assembly and a motor including the same that can improve motor performance while reducing a thickness thereof by including a sealing part having a new structure therein.

2. Description of the Related Art

A hard disk drive (HDD), an information storage device, reads data stored on a disk or writes data to a disk using a read/write head.

Hard disk drives require a disk driving device capable of driving the disk. As the disk driving device, a compact spindle motor is used.

In the compact spindle motor, a hydrodynamic bearing assembly has been used. Oil is interposed in a clearance between a shaft, a rotating member of the hydrodynamic bearing assembly, and a sleeve, a fixed member thereof, such that the shaft is supported by fluid pressure generated in the oil.

In addition, in the hydrodynamic bearing assembly, a journal bearing is formed by the generation of fluid dynamic pressure. In order to form this journal bearing, dynamic pressure generating grooves having various shapes are formed in an outer peripheral surface of the shaft or an inner peripheral surface of the sleeve to allow a fluid to be pressurized, thereby serving as a bearing.

Meanwhile, in accordance with the trend for the miniaturization of electronic devices, a spindle motor used in an electronic device has been miniaturized. However, in the case of this compact motor, a bearing span thereof has been shortened, such that it is difficult to improve the performance of the motor.

In addition, in the case of the motor using the hydrodynamic bearing assembly, the fluid filling the bearing clearance should be maintained for a long period of time in a state in which it fills the clearance without being scattered. However, the possibility that the oil may be leaked to the outside due to external vibrations, impacts, or the like, is high while the motor is not in operation, as well as while the motor is in operation, so there has been difficulty in forming a fluid sealing part as a new structure.

### SUMMARY OF THE INVENTION

An aspect of the present invention provides to a hydrodynamic bearing assembly allow a bearing span length to be as long as possible, and a motor including the same.

Another aspect of the present invention provides a motor having improved performance through the inclusion therein of a unit capable of preventing fluid leakage while sealing the fluid by horizontal sealing.

According to an aspect of the present invention, there is provided a hydrodynamic bearing assembly including: a sleeve having a shaft hole into which a shaft is rotatably inserted; and a hub fixed to an upper end of the shaft and extended in an outer radial direction, wherein an upper surface of the sleeve and a lower surface of the hub have an oil interface formed therebetween to seal oil.

At least one of the upper surface of the sleeve and the lower surface of the hub may be provided with a pumping groove pumping a lubricating fluid in a direction away from the oil interface.

At least one of the upper surface of the sleeve and the lower surface of the hub may be provided with a tapered portion allowing an interval between the sleeve and the hub to widen in the outer radial direction.

The tapered portion provided in the at least one of the upper surface of the sleeve and the lower surface of the hub or a corresponding member facing the tapered portion may be provided with a pumping groove pumping a lubricating fluid in a direction away from the oil interface.

The pumping groove may have a spiral shape or a helical shape.

The hub may have a main wall part extended downwardly in an axial direction so as to correspond to an outer surface of an upper portion of the sleeve.

At least part of a portion in which the upper surface of the sleeve and the lower surface of the hub face each other may be provided with a leakage preventing part.

The leakage preventing part may be formed by significantly reducing an interval between the upper surface of the sleeve and the lower surface of the hub such that a labyrinth seal is formed in the at least part of the portion in which the upper surface of the sleeve and the lower surface of the hub face each other.

At least one of an outer diameter of the shaft and an inner diameter of the sleeve may be provided with at least one journal bearing in order to generate dynamic pressure in a lubricating fluid filling a bearing clearance between the shaft and the sleeve at the time of rotation of the shaft.

The journal bearing may be provided as a groove having any one of a herringbone shape, a spiral shape, and a helical shape.

The shaft may include a stopper provided in a lower portion thereof in an axial direction, the stopper being caught by a lower end of the sleeve.

At least one of an upper surface of the stopper and a lower surface of the sleeve may be provided with a thrust dynamic pressure generating groove.

The thrust dynamic pressure generating groove may have any one of a herringbone shape, a spiral shape, and a helical shape.

According to another aspect of the present invention, there is provided a spindle motor including: a base member; a stator core mounted on the base member, disposed to correspond to a magnet provided in a rotating member, having a coil wound therearound to interact with the magnet, the coil generating electromagnetic force; and the hydrodynamic bearing assembly as described above coupled to the base member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor including a hydrodynamic bearing assembly according to an embodiment of the present invention;

FIG. 2 is an enlarged cross-sectional view of part A of FIG. 1 showing a structure of the hydrodynamic bearing assembly according to the embodiment of the present invention;

FIG. 3 is a cross-sectional view showing a sleeve according to an embodiment of the present invention; and

FIG. 4 is a perspective view showing a hub according to an embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

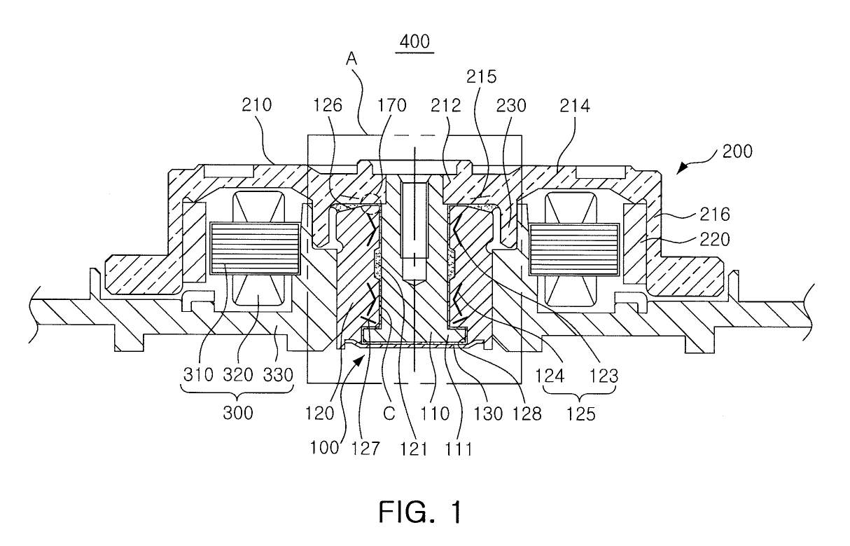

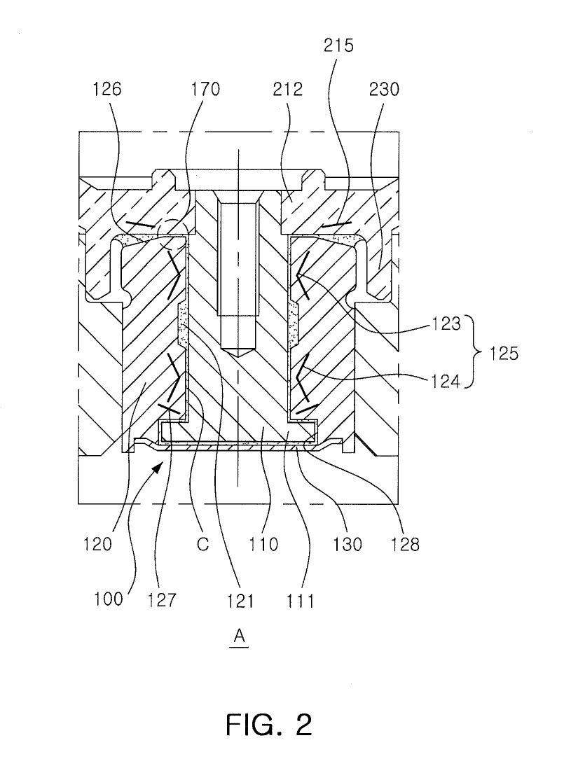

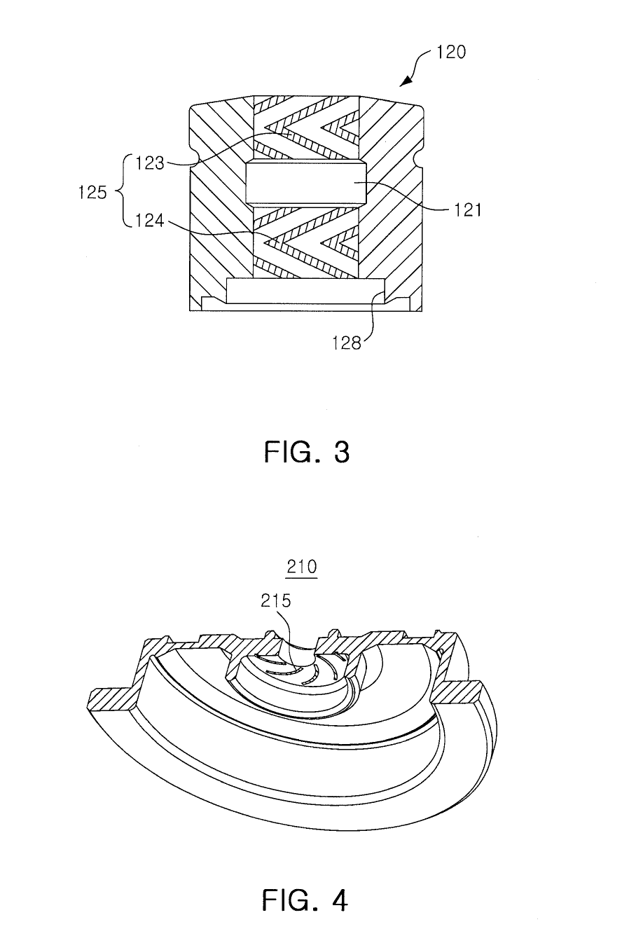

FIG. 1 is a schematic cross-sectional view showing a motor including a hydrodynamic bearing assembly according to an embodiment of the present invention; FIG. 2 is an enlarged cross-sectional view of part A of FIG. 1 showing a structure of the hydrodynamic bearing assembly according to the embodiment of the present invention; FIG. 3 is a cross-sectional view showing a sleeve according to the embodiment of the present invention; and FIG. 4 is a perspective view showing a hub according to the embodiment of the present invention.

Referring to FIGS. 1 through 4, a motor 400 including a hydrodynamic bearing assembly 100 according to the embodiment of the present invention may include a hydrodynamic bearing assembly 100 including a shaft 110 and a sleeve 120, a rotor 200 including a hub 210, and a stator 300 including a core 310 having a coil 320 wound therearound.

The hydrodynamic bearing assembly 100 may include the shaft 110, the sleeve 120, and the hub 210, and the hub 210 may be a component configuring the hydrodynamic bearing assembly 100 while simultaneously being a component configuring the rotor 200 to be described below.

Terms with respect to directions will be first defined. As viewed in FIGS. 1 through 4, an axial direction refers to a vertical direction based on the shaft 110, and an outer or inner radial direction refers to a direction toward an outer edge of the hub 210 based on the shaft 110 or a direction toward the center of the shaft 110 based on the outer edge of the hub 210.

In addition, an end portion (an upper end, a lower end, a distal end, or the like) of any member, hole, groove, or the like, may indicate the end thereof and also a portion adjacent thereto.

The shaft 110 is a rotating member rotatably inserted into a shaft hole of the sleeve 120 to be described below. The shaft 110 may include a stopper 111 provided at a lower end thereof in the axial direction, wherein the stopper 111 may have a diameter larger than that of the shaft 110. An upper surface of the stopper 111 may be caught by a lower end of the sleeve 120 to be described below to thereby limit floating of the shaft 110. The stopper 111 may be integrally formed with the shaft 110 or be provided as a separate member, and be fixed to the shaft 110 by various methods such as a press-fitting method, an adhesive adhesion method, and the like.

Further, according to the embodiment of the present invention, a thrust dynamic pressure generating groove 127 capable of generating thrust dynamic pressure may be provided in a lower surface of the sleeve 120 corresponding to the upper surface of the stopper 111. The thrust dynamic pressure generating groove 127 may also be provided in the upper surface of the stopper 111 corresponding to the lower surface of the sleeve 120. The thrust dynamic pressure generating groove 127 may have any shape such as a herringbone shape, a helical shape, a spiral shape, or the like, as long as it can generate dynamic pressure by fluid pumping.

The sleeve 120 may support the shaft 110 such that an upper end of the shaft 110 is protruded upwardly in the axial direction, and may be formed by forging Cu or Al or sintering Cu—Fe based alloy powders or SUS based powders.

Here, the shaft 110 may be inserted into the shaft hole of the sleeve 120 so as to have a micro clearance therebetween to thereby serve as a bearing clearance C. The bearing clearance may be filled with oil (a lubricating fluid), and the rotation of the rotor 200 may be more smoothly supported by a journal bearing 125 formed in at least one of an outer diameter of the shaft 110 and an inner diameter of the sleeve 120. Although FIGS. 1 through 3 show the journal bearing 125 including first and second dynamic pressure generating grooves 123 and 124 provided in upper and lower portions in the axial direction, the present invention is not limited thereto. That is, the number of dynamic pressure generating grooves is not limited.

The journal bearing 125 may be formed in an inner peripheral surface of the sleeve 120, which is an inner portion of the shaft hole of the sleeve 120, or an outer peripheral surface of the sleeve 120, and generate dynamic pressure by the lubricating fluid filling the bearing clearance C at the time of rotation of the shaft 110 in the shaft hole of the sleeve 120 to thereby allow the shaft 110 to smoothly rotate in the shaft hole of the sleeve 120.

However, the journal bearing 125 is not limited to being formed in the inner peripheral surface of the sleeve 120 as described above, but may also be formed in an outer diameter portion of the shaft 110. In addition, the number of journal bearings is not limited.

The journal bearing 125 may have any one of a herringbone shape, a spiral shape, and a helical shape, and may have any shape as long as it can generate radial dynamic pressure.

In addition, a reservoir 121 may be provided between the first and second dynamic pressure generating grooves 123 and 124, the reservoir 121 being recessed in the inner peripheral surface of the sleeve 120 in the outer radial direction. The reservoir 121 may store the lubricating fluid therein to thereby prevent negative pressure from being generated even in the case in which the fluid is pumped by the dynamic pressure generating grooves.

Further, the stopper 111 may be provided at the lower end of the shaft 110 and be caught by the lower surface of the sleeve 120 to thereby serve to prevent the floating of the rotating members (the shaft, the rotor, and the like). Therefore, according to the embodiment of the present invention, the thrust dynamic pressure generating groove 127 capable of generating thrust dynamic pressure may be provided in the lower surface of the sleeve 120. The thrust dynamic pressure generating groove 127 may also be provided in the upper surface of the stopper corresponding to the lower surface of the sleeve 120. The thrust dynamic pressure generating groove 127 may have any shape such as a herringbone shape, a helical shape, a spiral shape, or the like, as long as it can generate dynamic pressure by fluid pumping.

In addition, the sleeve 120 may include a step groove 128 formed in a lower end thereof in the outer radial direction such that the stopper 111 may be caught by the lower end thereof and may be seated in the step groove 128.

In addition, the motor 400 according to the embodiment of the present invention may further include the hub 210 fixed to the upper end of the shaft 110 and extended in the outer radial direction. The upper surface of the sleeve 120 and the lower surface of the hub 210 may have an oil interface formed therebetween such that oil may be sealed therein. Therefore, according to the embodiment of the present invention, at least one of the upper surface of the sleeve 120 and the lower surface of the hub 210 may be provided with a tapered portion 126 allowing an interval between the sleeve 120 and the hub 210 to widen in the outer radial direction.

In addition, at least one of the upper surface of the sleeve 120 and the lower surface of the hub 210 may be provided with a pumping groove 215 pumping the lubricating fluid in a direction away from the oil interface, whereby leakage of the fluid may be prevented. Further, the pumping groove 215 may be formed in the tapered portion 126 or a corresponding member (the sleeve 120 or the hub 210) corresponding to a position at which the tapered portion 126 is provided. Here, the pumping groove 215 may have a spiral shape or a helical shape.

The sleeve 120 may include a circulation hole (not shown) formed therein so as to allow upper and lower portions thereof to be in communication with each other, such that the pressure of oil in an inner portion of the hydrodynamic bearing assembly 100 may be dispersed to thereby maintain balance, and air bubbles, or the like, present in the inner portion of the hydrodynamic bearing assembly 100 may be moved to be discharged by circulation.

In addition, the journal bearing 125 may be provided such that the lubricating fluid is pumped downwardly in the axial direction. That is, the sum of pumping force of the first dynamic pressure generating groove 123 and pumping force of the second dynamic pressure generating groove 124 may be directed downwardly in the axial direction. In addition, the bearing clearance formed between the shaft 110 and the sleeve 120 may be filled with the lubricating fluid by a full-fill structure.

In addition, the reservoir 121 may be provided between the first and second dynamic pressure generating grooves 123 and 124 to be recessed in the inner peripheral surface of the sleeve 120 in the outer radial direction. The reservoir 121 may store the lubricating fluid therein to thereby prevent negative pressure from being generated even in the case in which the fluid is pumped by the dynamic pressure generating grooves.

Further, the sleeve 120 may have a base cover 130 coupled thereto at a lower portion thereof in the axial direction, having a clearance therebetween, wherein the clearance receives the oil therein.

The base cover 130 may receive the oil in the clearance between the base cover 130 and the sleeve 120 to thereby serve as a bearing supporting the lower surface of the shaft 110.

The hub 210 is a rotating member coupled to the shaft 110 and rotating together with the shaft 110. The hub 210 may configure the rotor 200 while simultaneously configuring the hydrodynamic bearing assembly 100. Hereinafter, the rotor 200 will be described in detail.

The rotor 200 is a rotating structure provided to be rotatable with respect to the stator 300. The rotor 200 may include the hub 210 having an annular ring-shaped magnet 220 provided on an inner peripheral surface thereof, and the annular ring-shaped magnet 220 corresponds to the core 310 to be described below, having a predetermined interval therebetween.

In other words, the hub 210 may be a rotating member coupled to the shaft 110 to thereby rotate together with the shaft 110.

Here, the magnet 220 may be a permanent magnet generating magnetic force having a predetermined strength by alternately magnetizing N and S poles thereof in the circumferential direction.

In addition, the hub 210 may include a first cylindrical wall part 212 fixed to the upper end of the shaft 110, a disk part 214 extended from an end portion of the first cylindrical wall part 212 in the outer radial direction, and a second cylindrical wall part 216 protruded downwardly from an end portion of the disk part 214 in the outer radial direction, wherein the second cylindrical wall part 216 may include the magnet 220 coupled to an inner peripheral surface thereof.

The hub 210 may have a main wall part 230 extended downwardly in the axial direction such that it corresponds to an outer surface of the upper portion of the sleeve 120.

In addition, according to the embodiment of the present invention, the oil interface is formed between the upper surface of the sleeve 120 and the lower surface of the hub 210, such that the oil may be sealed. Therefore, at least one of the upper surface of the sleeve 120 and the lower surface of the hub 210 may be provided with the tapered portion 126 allowing the interval between the sleeve 120 and the hub 210 to widen in the outer radial direction.

In addition, at least one of the upper surface of the sleeve 120 and the lower surface of the hub 210 may be provided with the pumping groove 215 pumping the lubricating fluid in a direction away from the oil interface, whereby the leakage of the fluid may be prevented. Further, the pumping groove 215 may be formed in the tapered portion 126 or a corresponding member (the sleeve 120 or the hub 210) corresponding to a position at which the tapered portion 126 is provided. Here, the pumping groove 215 may have a spiral shape or a helical shape.

In addition, a leakage preventing part 170 may be provided in at least part of a portion in which the upper surface of the sleeve 120 and the lower surface of the hub 210 face each other. The leakage preventing part 170 may be formed by significantly reducing an interval between the upper surface of the sleeve 120 and the lower surface of the hub 210 such that a labyrinth seal is formed in at least part of the portion in which the upper surface of the sleeve 120 and the lower surface of the hub 210 face each other. The labyrinth seal allows for a minimal interval between members, thus having a sealing role capable of preventing the leakage of the lubricating fluid.

Further, in a case in which a liquid-vapor interface is formed in the portion in which the upper surface of the sleeve 120 and the lower surface of the hub 210 face each other as in the present embodiment, since a horizontal sealing part (a sealing part formed in the outer radial direction) is formed, greater attention to the leakage of the lubricating fluid is required.

Meanwhile, a thrust dynamic pressure generating groove (not shown) may be formed in at least one of the upper surface of the sleeve 120 and the lower surface of the hub 210 in the portion in which the leakage preventing part 170 having the labyrinth seal formed therein is provided to thereby generate thrust dynamic pressure. According to the embodiment of the present invention, since the sum of the pumping forces of the first and second dynamic pressure generating grooves 123 and 124, which form the journal bearing 125, may be provided to pump the lubricating fluid downwardly in the axial direction, the thrust dynamic pressure generating groove may be additionally provided in the leakage preventing part 170 in order to generate required thrust dynamic pressure.

The stator 300 may include the coil 320, the core 310, and a base member 330.

In other words, the stator 300 may be a fixed structure including the coil 320 generating electromagnetic force having a predetermined magnitude when power is applied thereto, and the plurality of cores 310 having the coil 320 wound therearound.

The core 310 may be fixedly disposed on an upper portion of the base member 330 including a printed circuit board (not shown) having circuit patterns printed thereon, and a plurality of coil holes having a predetermined size may be formed to penetrate through the base member 330 so as to expose the winding coil 320 downwardly in the upper surface of the base member 330 corresponding to the winding coil 320. The winding coil 320 may be electrically connected to the printed circuit board (not shown) so that external power is supplied thereto.

The outer peripheral surface of the sleeve 120 may be fixed to the base member 330 and the core 310 having the coil 320 wound therearound may be inserted into the base member 330. In addition, the base member 330 and the sleeve 120 may be assembled to each other by applying an adhesive to an inner surface of the base member 330 or the outer surface of the sleeve 120.

In the case of the spindle motor according to the embodiment of the present invention, the horizontal sealing part is used therein, whereby the bearing assembly capable of increasing bearing rigidity of the rotating member may be provided. In addition, since the structure of the bearing assembly according to the embodiment of the present invention may be easily manufactured through a simple modification of an existing manufacturing scheme, a manufacturing line according to the related art may be used as it is.

As set forth above, in a hydrodynamic bearing assembly and a motor including the same according to embodiments of the present invention, a horizontal sealing part is provided to secure a dynamic bearing having a span length as long as possible, whereby the performance of the motor may be improved.

In the case of a motor using a hydrodynamic bearing assembly, a fluid filling a bearing clearance should be maintained for a long period of time in a state in which it fills the clearance without being scattered. According to embodiments of the present invention, a fluid sealing part having a novel structure, addressing a disadvantage of a high possibility that oil may be leaked to the outside due to external vibrations, impacts, or the like while the motor is not in operation, as well as while the motor is in operation, is provided, whereby the performance of the motor may be improved.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a sleeve having a shaft hole into which a shaft is rotatably inserted; and
a hub fixed to an upper end of the shaft and extended in an outer radial direction,
wherein an upper surface of the sleeve and a lower surface of the hub have an oil interface formed therebetween to seal oil.

2. The hydrodynamic bearing assembly of claim 1, wherein at least one of the upper surface of the sleeve and the lower surface of the hub is provided with a pumping groove pumping a lubricating fluid in a direction away from the oil interface.

3. The hydrodynamic bearing assembly of claim 1, wherein at least one of the upper surface of the sleeve and the lower surface of the hub is provided with a tapered portion allowing an interval between the sleeve and the hub to widen in the outer radial direction.

4. The hydrodynamic bearing assembly of claim 3, wherein the tapered portion provided in the at least one of the upper surface of the sleeve and the lower surface of the hub or a corresponding member facing the tapered portion is provided with a pumping groove pumping a lubricating fluid in a direction away from the oil interface.

5. The hydrodynamic bearing assembly of claim 4, wherein the pumping groove has a spiral shape or a helical shape.

6. The hydrodynamic bearing assembly of claim 1, wherein the hub has a main wall part extended downwardly in an axial direction so as to correspond to an outer surface of an upper portion of the sleeve.

7. The hydrodynamic bearing assembly of claim 1, wherein at least part of a portion in which the upper surface of the sleeve and the lower surface of the hub face each other is provided with a leakage preventing part.

8. The hydrodynamic bearing assembly of claim 7, wherein the leakage preventing part is formed by significantly reducing an interval between the upper surface of the sleeve and the lower surface of the hub such that a labyrinth seal is formed in the at least part of the portion in which the upper surface of the sleeve and the lower surface of the hub face each other.

9. The hydrodynamic bearing assembly of claim 1, wherein at least one of an outer diameter of the shaft and an inner diameter of the sleeve is provided with at least one journal bearing in order to generate dynamic pressure in a lubricating fluid filling a bearing clearance between the shaft and the sleeve at the time of rotation of the shaft.

10. The hydrodynamic bearing assembly of claim 9, wherein the journal bearing is provided as a groove having any one of a herringbone shape, a spiral shape, and a helical shape.

11. The hydrodynamic bearing assembly of claim 1, wherein the shaft includes a stopper provided in a lower portion thereof in an axial direction, the stopper being caught by a lower end of the sleeve.

12. The hydrodynamic bearing assembly of claim 11, wherein at least one of an upper surface of the stopper and a lower surface of the sleeve is provided with a thrust dynamic pressure generating groove.

13. The hydrodynamic bearing assembly of claim 12, wherein the thrust dynamic pressure generating groove has any one of a herringbone shape, a spiral shape, and a helical shape.

14. A spindle motor comprising:
a base member;
a stator core mounted on the base member, disposed to correspond to a magnet provided in a rotating member, having a coil wound therearound to interact with the magnet, the coil generating electromagnetic force; and
the hydrodynamic bearing assembly of claim 1 coupled to the base member.
